(19) United States
(12) Patent Application Publication
(10) Pub. No.: US 2009/0087569 A1
(43) Pub. Date: Apr. 2, 2009

(54) Methods for Preparing Highly Stable Hyaluronic Acid

(75) Inventors: Shufeng FAN, Nanjing (CN); Juan Liu, Nanjing (CN); Juhong Zhu, Nanjing (CN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Fenchem Enterprises Ltd., Nanjing (CN)

(21) Appl. No.: 11/862,315

(22) Filed: Sep. 27, 2007

(51) Int. Cl. B05D 3/02

(52) U.S. Cl. 427/372.2

(57) ABSTRACT

Embodiments of the present disclosure relate to methods for preparing highly stable HA. Preparation of the highly stable HA comprises the steps of: preparing HA or its salt solution; preparing a water solution of negative-charge-carrying coat material; preparing a solution of positive-charge-carrying coat material; HA or its salt: negative-charge-carrying coat material: positive-charge-carrying coat material that ranges 1:1:2˜1:4:8; preparing a water solution of Hydroxypropyl methylcellulose; embedding for the first time: mixing HA or hyaluronate salt, negative-charge-carrying coat material and positive-charge-carrying coat material with the above mentioned proportion; embedding for the second time: adding water solution of Hydroxypropyl methylcellulose to the above mixture at a mass proportion 1:1 obtaining a second embedded compound; drying and solidifying the compound obtained from the second embedding using a spray dry method. The method for preparing HA microcapsules using the present disclosure is able to improve stability of the microcapsule, helping unique molecular structure and physical and chemical nature keep stable, which is very useful for food industry.

### FIELD OF THE INVENTION

The present disclosure relates to a method for preparing a macromolecular compound, in particular, a method for preparing a highly stable hyaluronic acid (HA) using embedding technology.

### BACKGROUND

Hyaluronic acid (HA, also called Hyaluronan) is a mucopolysaccharide that is an extremely large molecule composed of repeat disaccharide units of N-acetylglucosamine and glucuronic acid. The molecular weight ranges from thousands to millions of Daltons. HA widely exists in the extracellular space of human and animal tissue, vitreum, umbilical cord, skin, joints synovia, and cockscomb etc. with the function of cushioning and lubricating. It has especially important roles in joints as lubricant between joint surfaces and rigidity to the vertebrate disks, and it is also a constituent of major importance in the vitreous body of the eye. In the skin, it provides hydration to the tissue and helps in the transportation of nutrients.

HA is very unstable in conditions that temperature higher than 60° C. or a pH lower than 5 or higher than 10, which limits the application of HA in food products. To expand application of HA, some adornments to HA are needed in order to help HA resist adverse effects brought about by pH or temperature extremes.

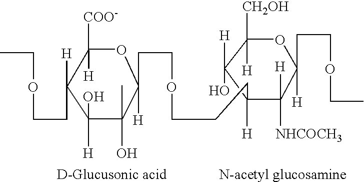

Micro-encapsulation techniques use natural or synthetic film-forming material (coat material) to encapsulate liquid or solid (core) medicaments, forming microcapsules that have a diameter of 1˜5000 μm (usually 5˜250 μm). Microcapsules are of great significance in that: it can make the core in the microcapsule more resistant to pH, oxygen, dampness, hotness (high temperatures), light and other adverse elements, preventing damage from occurring; it is able to prevent the core from spreading or giving off, avoiding effective ingredients in the core from volatilizing, making the core more stable and enduring; it can control the release of materials in the core, to help the most effective ingredients in the core take effect; it can refrain the core from giving off unpleasant odor making the core better in regard to smell and taste; it can change the physical and chemical nature of the core by transforming liquid or semi-solid liquid material to a flowing solid powder easy to be stored and shipped.

Since hyaluronic acid itself is a kind of polysaccharides, many researchers intended to use hyaluronic acid as a coat material, but have not been successful.

At present there are a great deal researchers trying to modify hyaluronic acid in order to expand its use in the medical field, with most of them applying chemical methods as cross-linking or esterificating maneuvers to improve physical strength or reduce decomposition speed in vivo.

The patent CN200610039972.7 discloses a cross-linking compound that linked HA to carboxymethyl cellulose (CMC). Although the linked HA is more stable, it is not widely used in food industry because it is insoluble in water.

The patent US20060188518 discloses a method for preparing nanometer-level HA, from which a single-core microcapsule is achieved, which has just one layer of chitosan. This kind of microcapsule is not stable because it is easy to break up.

### SUMMARY

Technical problem: The present disclosure provides an embedding technology for preparing highly stable double-core HA microcapsules. The coat material itself carries positive and negative electric charges forming a wall of the microcapsule when the charges interact with each other. This advantage makes it easy to select coat materials. Additionally, a spray dry technique (also termed “spraying dry technique”) is applied whose production process is simple, and is easy to operate and control.

Technical solution: Methods for preparing highly stable HA, comprises the steps of: preparing HA or its salt solution whose proper mass concentration is from 0.1˜0.25%; preparing a water solution of negative-charge-carrying coat material whose mass concentration is from 1.5˜3%; prepare solution of positive-charge-carrying coat material whose mass concentration is from 0.1˜1.3% and pH is from 3.5˜6.5; HA or its salt: negative-charge-carrying coat material: positive-charge-carrying coat material ranges from 1:1:2˜1:4:8; preparing a water solution of Hydroxypropyl methylcellulose (HPMC) whose appropriate mass concentration is from 0.1˜3%; embedding for the first time: mixing HA or hyaluronate salt, negative-charge-carrying coat material and positive-charge-carrying coat material with the above mentioned proportion, stirring the mixture at room temperature for 30˜60 min; embedding for the second time: adding a water solution of HPMC to the above mixture at a mass proportion 1:1, stirring at room temperature for 30˜60 min obtaining a compound from the second embedding; drying and solidifying; drying and solidifying the compound from the second embedding using a spray dry method, the feeding speed is from 20 mL/min˜25 mL/min, and the inlet temperature is from 60° C.˜150° C. and the outlet temperature is from 40° C.˜90° C. Preferably, the hyaluronate salt is sodium salt. The negative-charge-carrying coat material is sodium alginate and arabic gum. The positive-charge-carrying coat material is Chitosan and collagen material. The solution of positive-charge-carrying coat material is acidic solution of chitosan or a water solution of collagen. Preferably, the mass concentration of the water solution of sodium alginate is 2.5%. The mass concentration and pH of the acidic solution of chitosan are preferably 0.8% and 5.5, respectively. Preferably, the mass proportion of HA, sodium alginate and chitosan is 1:3:6. The preferable parameters for spraying dry are: 23 mL/min for the feeding speed, 80° C.˜120° C. for the inlet temperature, and 50° C.˜70° C. for the outlet temperature.

Both sodium alginate and chitosan are excellent but inexpensive natural macromolecular materials, having good bio-compatibility and bio-degradability. In terms of structure the sodium alginate is polymerized by β-1,4 D-mannuronic sodium (M) and α-1,4 L-guluronic sodium (G). Chitosan is a natural macromolecular straight-chain polysaccharide obtained from deacetyl of chitin, whose chemical name is (1-4)-2-amino-2-deoxy-β-D-dextran. Having a great many of the carboxy groups on the molecular chain, sodium alginate can react with chitosan (having a great many of the primary amine groups) forming an electrolyte-massed membrane via attraction between the positive and negative changes. Therefore, sodium alginate and chitosan can jointly make up an electrolyte-massed membrane by attraction between positive and negative charges, as shown in Scheme 1 below:

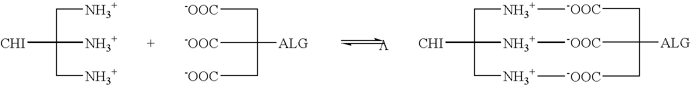

In addition to sodium alginate (that carry negative charges) and chitosan (that carry positive charges), negative-charge-carrying arabic gum and positive-charge-carrying collagen material can act as a coat material.

Hydroxypropyl methylcellulose (HPMC) is from part of the methyl and hydroxypropyl ether of cellulose, being proved as safe food ingredients by researchers. This material is chemically stable with little electrostatic absorption to contents. A great deal of experiments reveal that HPMC breaks up when the entire capsule crust crashes, becoming soluble, quickly, at any pH, thus HPMC can act as capsule crust for fast release formulations. The pH of acidic solution of chitosan may effect the stability of HA when sodium alginate chelates chitosan, therefore, HPMC is added in order to prevent HA from losing in the ensuing procedures and to improve availability of HA.

Preparation of microcapsules using a spraying dry method functions to spread the core material into the solution of the coat material and evenly mix it. Then the mixture is sprayed in hot air evaporating solvent that solves the coat material and microcapsules are eventually produced. Due to the embedding effect of semi-permeable membrane on the product, materials that are volatile and unstable are protected. In addition, the coat material is a water soluble macromolecule helping to improve solubility. Therefore, microcapsules prepared by this method are water soluble and convenient for usage.

Beneficial effects of the disclosure: The HA embedding rate can be as high as about 85% by the methods provided by the present disclosure, with microcapsule diameters ranging 50˜200 μm. The present disclosure enjoys many advantages such as, but not limited to: the embedded HA is stable enough to effectively decrease the effect of pH and temperature on the activity of the core material, preventing the core material from spreading to its surroundings, and from losing active ingredients, which are very useful for storage. The coat material of the microcapsule contains less water, thereby, being able to resist high temperature, helping HA be stable without interfering with in vivo release and absorption of HA. In addition, microcapsules take ultimate shape using the spraying dry technique that is very easy, fast, and cost effective. The spraying dry technique can help obtain dried product directly omitting steps such as steaming, crystallization, filtering, and grinding. The above advantages enjoyed by HA microcapsules prepared using the present disclosure helps to extend usage of HA to food industry.

The present disclosure tries to help hyaluronic acid to form microcapsule products, which are very stable and can be added into foods and beverages without being decomposed, owing to which the core can enter into human body taking effects.

The present disclosure uses hyaluronic acid as a core material preparing microcapsules that apply hyaluronic acid as active material.

There are few researchers focused on enhancing HA thermal stability so as to extend its usage in food industry.

The present disclosure can be used to prepare double-core microcapsules of HA that are more stable. This double-core product can stay stable in very hot ambience, very useful for food and beverage industry that often uses high temperature processes.

In this specification, the term “HA” means hyaluronic acid and any of hyaluronate salts. Hyaluronate salts according to the present disclosure include, but are not limited to, inorganic salts such as sodium hyaluronate, potassium hyaluronate and calcium hyaluronate etc, and organic salts such as tetrabultylammonium salt etc. Preferable hyaluronate salt of HA according to the present disclosure is sodium hyaluronate.

### BRIEF DESCRIPTION OF THE DRAWINGS

FIG. 1 illustrates the effect of the sodium alginate concentration on the microcapsule. This figure reveals that as the concentration of sodium alginate increases, the drug-carrying amount and the embedding rate of microcapsules rises when the concentration is <2.5%, and the amount and rate step drops down as the concentration stepping up after the 2.5% cut point.

FIG. 2 illustrates the effect of chitosan concentration on the microcapsule. This figure reveals that as chitosan concentration rises, the drug-carrying amount and the embedding rate of the microcapsule step up, and when the concentration is beyond the cut point of 0.8%, the amount and rate begin to step down.

FIG. 3 illustrates the effect of pH of chitosan on the microcapsule. This figure illustrates that as pH<5.5, the drug-carrying amount and the embedding rate of the microcapsule step up with pH rising, and when pH>5.5, the amount and rate become slightly decreased.

FIG. 4 illustrates the effect of mass ratio between HA, sodium alginate and chitosan on the microcapsule. This figure illustrates that the drug-carrying amount and the embedding rate of the microcapsule step up with mass of sodium alginate and chitosan rising, however, when the ratio passes 1:3:6, the amount and rate step down.

FIG. 5 illustrates the effect of feeding speed on the microcapsule. This figure illustrates that with the feeding speed growing faster, microcapsule efficiency slightly decreases. When the feeding speed is at 23 mL/min, the efficiency reaches the maximum.

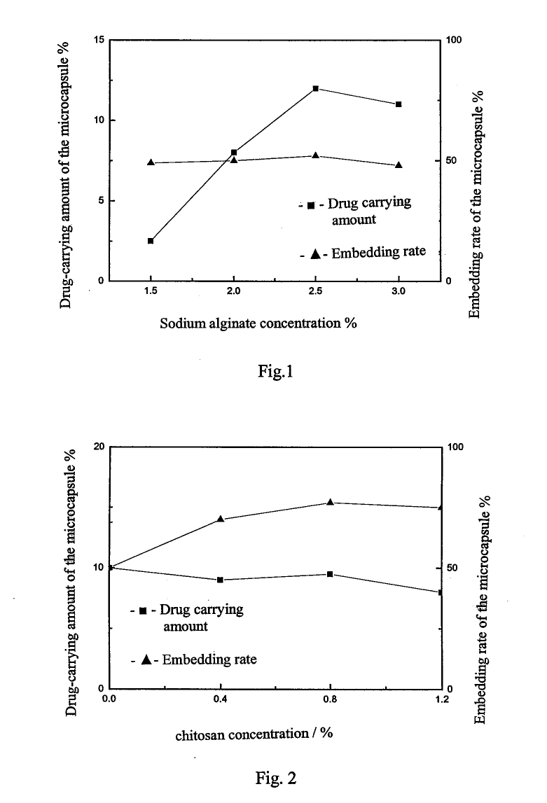

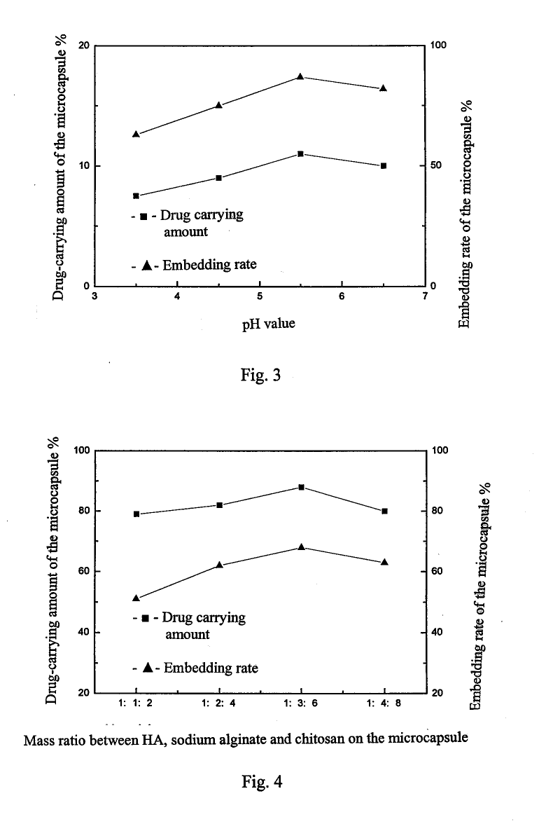

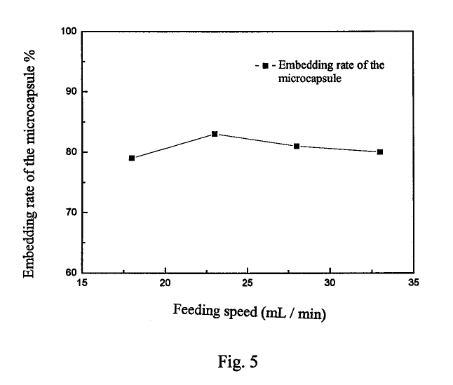

### DETAILED DESCRIPTION OF THE EMBODIMENTS

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, biology, physics, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in atmosphere. Standard temperature and pressure are defined as 25° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

Now having described embodiments of present disclosure in general, the following describes some embodiments of present disclosure and uses thereof. The following are a non-limiting illustrative examples of embodiments of the present disclosure that is not intended to limit the scope of any embodiment of the present disclosure, but rather is intended to provide some experimental conditions and results. Therefore, one skilled in the art would understand that many experimental conditions can be modified, but it is intended that these modifications be within the scope of the embodiments of the present disclosure.

### EXAMPLE 1

1) Prepare water solution of HA that has a mass concentration of 0.15%;

2) Prepare water solution of sodium alginate (Qingdao Nanyang Algae Industry Co. Ltd.) that has a mass concentration of 1.5%, stir with magnetic stir bar (Shanghai Meiyingpu Devices & Meters) with the water solution of HA at room temperature;

3) Prepare acidic solution of chitosan (C.E. Roeper GmbH) that has a pH of 3.5 and a mass concentration of 0.1%, stir this solution with the solution obtained from step 2), in which the mass ratio of hyaluronic acid:sodium alginate:chitosan is 1:1:2;

4) Prepare water solution of HPMC (Shandong Yutian Chemicals) that has a mass concentration 0.2%, stir this solution with solution obtained from step 3) using a magnetic bar in room temperature;

5) Transfer the mixture to a spraying dry machine (Shanghai Tianshun Bio-engineering Co. Ltd.), controlling the feeding speed at 20 mL/min, the inlet temperature at 80° C.˜120° C. and the outlet temperature at 50° C.˜70° C.

Ultimately, embedding rate of HA of the microcapsule is as high as 76%.

### EXAMPLE 2

1) Prepare water solution of HA that has a mass concentration of 0.15%;

2) Prepare water solution of sodium alginate that has a mass concentration of 2.5%, mix this solution with the water solution of hyaluronic acid using magnetic bar at room temperature;

3) Prepare acidic solution of chitosan that has a pH of 5.5 and a mass concentration of 0.8%, mix this solution with solution from step 2) using magnetic bar at room temperature, in which mass ratio between hyaluronic acid:sodium alginate:chitosan is 1:3:6;

4) Prepare water solution of HPMC that has a mass concentration of 0.2%, mix this solution with solution from step 3) at equal mass ratio at room temperature;

5) Transfer the mixture to a spraying dry machine, controlling the feeding speed at 23 mL/min, the inlet temperature at 80° C.˜120° C. and the outlet temperature at 50° C.˜70° C.

Ultimately, embedding rate of HA of the microcapsule is as high as 85%.

### EXAMPLE 3

1) Prepare water solution of HA that has a mass concentration of 0.15%;

2) Prepare water solution of sodium alginate that has a mass concentration of 3%, mix this solution with the water solution of hyaluronic acid using magnetic bar at room temperature;

3) Prepare acidic solution of chitosan that has a pH of 6.5 and mass concentration of 1.2%, mix this solution with solution from step 2) using magnetic bar at room temperature, in which mass ratio between hyaluronic acid:sodium alginate:chitosan is 1:4:8;

4) Prepare water solution of HPMC that has a mass concentration of 0.2%, mix this solution with solution from step 3) at equal mass ratio at room temperature;

5) Transfer the mixture to a spraying dry machine, controlling the feeding speed at 25 mL/min, the inlet temperature at 80° C.˜120° C. and the outlet temperature at 50° C.˜70° C.

Ultimately, embedding rate of HA of the microcapsule is as high as 81%.

### EXAMPLE 4

1) Prepare water solution of HA that has a mass concentration of 0.15%;

2) Prepare water solution of arabic gum that has a mass concentration of 2.5%, mix this solution with the water solution of hyaluronic acid using magnetic bar at room temperature;

3) Prepare water solution of collagen material that has a mass concentration of 0.8%, mix this solution with solution from step 2) using magnetic bar at room temperature, in which mass ratio between hyaluronic acid:arabic gum:collagen material is 1:3:6;

4) Prepare water solution of HPMC that has a mass concentration of 0.2%, mix this solution with solution from step 3) at equal mass ratio at room temperature;

5) Transfer the mixture to a spraying dry machine, controlling feeding speed at 23 mL/min, the inlet temperature at 80° C.˜120° C. and the outlet temperature at 50° C.˜70° C.

Ultimately, embedding rate of HA of the microcapsule is as high as 80%.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include ±10%, or more of the numerical value(s) being modified. In addition, the phrase “about ‘x’ to ‘y’” includes “about ‘x’ to about ‘y’”.

Many variations and modifications may be made to the above-described embodiments. All such modifications and variations are intended to be included herein within the scope of this disclosure and protected by the following claims.

We claim the following:

1. A method for preparing highly stable hyaluronic acid, comprising the following steps:
a. Preparing materials: preparing HA or its salt solution whose proper mass concentration ranges 0.1˜0.25%; preparing a water solution of negative-charge-carrying coat material whose mass concentration ranges 1.5˜3%; preparing a solution of positive-charge-carrying coat material whose mass concentration ranges 0.1˜1.3% and pH is adjusted between 3.5˜6.5; HA or its salt: negative-charge-carrying coat material: positive-charge-carrying coat material ranges 1:1:2˜1:4:8; preparing a water solution of HPMC whose appropriate mass concentration ranges 0.1˜3%;
b. Embedding for the first time: mixing HA or hyaluronate salt, negative-charge-carrying coat material and positive-charge-carrying coat material with the said proportion, stir the mixture at room temperature for 30˜60 min;
c. Embedding for the second time: adding a water solution of HPMC to the said mixture at a mass proportion 1:1, stirring at room temperature for 30˜60 min obtaining a compound obtaining from the second embedding;
d. Drying and solidifying; drying and solidifying the compound obtained from the second embedding using a spray dry method, the feeding speed is 20 mL/min˜25 mL/min, and inlet temperature is 60° C.˜150° C. and outlet temperature is 40° C.˜90° C.

2. A method for preparing a highly stable HA as in claim 1, wherein the salt of HA is preferably sodium hyaluronate.

3. A method for preparing a highly stable HA as in claim 1, wherein the negative-charge-carrying coat material is sodium alginate and arabic gum.

4. A method for preparing a highly stable HA as in claim 1, wherein the positive-charge-carrying coat material is Chitosan and collagen material.

5. A method for preparing a highly stable HA as in claim 1, wherein solution of positive-charge-carrying coat material is acidic solution of chitosan or water solution of collagen.

6. A method for preparing a highly stable HA as in claim 1, wherein the mass concentration of water solution of sodium alginate is preferably 2.5%.

7. A method for preparing a highly stable HA as in claim 1, wherein the mass concentration and pH of acidic solution of chitosan are preferably 0.8% and 5.5, respectively.

8. A method for preparing a highly stable HA as in claim 1, wherein optimum mass proportion of HA:sodium alginate:chitosan is about 1:3:6.

9. A method for preparing a highly stable HA as in claim 1, wherein the parameters for spraying dry are preferably 23 mL/min for feeding speed, 80° C.˜120° C. for inlet temperature, and 50° C.˜70° C. for outlet temperature.
